(19) United States
(12) Patent Application Publication
(10) Pub. No.: US 2026/0197883 A1
(43) Pub. Date: Jul. 9, 2026

(54) U2U RELAY RESELECTION

(71) Applicant: Kyocera Corporation, Kyoto (JP)

(72) Inventors: Henry CHANG, San Diego, CA (US); Masato FUJISHIRO, Yokohama (JP)

(21) Appl. No.: 19/130,066

(22) PCT Filed: Nov. 1, 2023
(86) PCT No.: PCT/US2023/036582

§ 371 Date: May 14, 2025

Related U.S. Application Data
(60) Provisional application No. 63/428,513, filed on Nov. 29, 2022.

(51) Int. Cl. H04W 76/14; H04W 40/22; H04W 88/04

(52) U.S. Cl. CPC H04W 76/14; H04W 40/22; H04W 88/04

(57) ABSTRACT

The devices, systems, and methods described herein are directed to scenarios in which a candidate relay UE device may have previous knowledge of a source UE device's interest in connecting to a specific target UE device, based on a previous request from the source UE device. If the candidate relay UE device determines that a sidelink connection between the candidate relay UE device and the target UE device meet the criteria for establishing a U2U relay connection between the source UE device and the target UE device, the candidate relay UE device should inform the source UE device without waiting for a next scheduled Model A transmission period.

### CLAIM OF PRIORITY

The present application claims priority to Provisional Application No. 63/428,513, entitled “U2U RELAY RESELECTION,” docket number TPRO 00379 US, filed Nov. 29, 2022, which is assigned to the assignee hereof and hereby expressly incorporated by reference in its entirety.

### FIELD

This invention generally relates to wireless communications and more particularly to relay reselection.

### BACKGROUND

Sidelink relaying functionality allows a user equipment (UE) device to connect with another UE device via a relay UE device.

### SUMMARY

The devices, systems, and methods described herein are directed to scenarios in which a candidate relay UE device may have previous knowledge of a source UE device's interest in connecting to a specific target UE device, based on a previous request from the source UE device. If the candidate relay UE device determines that a sidelink connection between the candidate relay UE device and the target UE device meet the criteria for establishing a U2U relay connection between the source UE device and the target UE device, the candidate relay UE device informs the source UE device without waiting for a next scheduled Model A transmission period.

### BRIEF DESCRIPTION OF THE DRAWINGS

FIG. 1A is a block diagram of an example of a system where a source user equipment (UE) device establishes a UE-to-UE (U2U) relay connection to a target UE device through a first relay UE device and a second relay UE device refrains from sending a response to a U2U establishment request.

FIG. 1B is a block diagram of an example of the system of FIG. 1A where the source UE device reestablishes the U2U relay connection with the target UE device through a second relay UE device.

FIG. 2 is a block diagram of an example of the user equipment devices of FIGS. 1A, 1B, 3A, and 3B.

FIG. 3A is a block diagram of an example of the system in which a source UE device establishes a first U2U relay connection to a first target UE device through a first relay UE device and second U2U relay connection to a second target UE device through a second relay UE device.

FIG. 3B is a block diagram of an example of the system where the source UE device establishes U2U relay connections with first and second target UE devices through a second relay UE device.

FIG. 4 is a flow chart of an example of a method performed at a relay UE device.

### DETAILED DESCRIPTION

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D).

In addition, one or more UE devices can be used as relay devices between a UE device and a destination where the relay device forwards data between a UE device and the destination. The destination may be a communication network or another UE device (e.g., destination UE device or target UE device). Where the destination device is another UE device, the relaying functionality is typically referred to as UE-to-UE (U2U) relaying.

The purpose for the sidelink U2U relaying functionality is mainly to allow two remote UE devices (e.g., a source UE device and a destination UE device) to (1) connect directly when the two remote UE devices are in close proximity, or (2) establish an indirect connection via a U2U relay UE device. When two UE devices are directly connected via a U2U connection, a deterioration of the radio condition (e.g., quality) of the direct path may be indicated by the detection of a Sidelink Radio Link Failure (SL-RLF) or if a Sidelink Reference Signal Received Power (SL-RSRP) measurement falls below a configured sidelink (SL) threshold value. If the radio condition of the direct path deteriorates, it may be necessary for the source UE device to find an alternate path to connect to the target UE device, oftentimes with the assistance of a relay UE device. In order to select a relay UE device that may be used as the alternate path to the target UE device, the source UE device needs to know if the candidate relay UE device is reachable by both the source UE device and the target UE device.

Typically, the decision for relay selection and reselection is based on discovery messages transmitted in accordance with either a Model A or a Model B discovery procedure. With Model A discovery, either the source UE device or the relay UE device may announce their presence by transmitting a discovery message indicating “I am here,” and the transmitting UE device does not expect a response to the message. In some examples, Model A discovery is used by the relay UE device to periodically broadcast its availability to serve as a U2U relay UE device. In further examples, the relay UE device will also include a Neighbor List (NL) in the discovery message, and the NL includes a list of UE devices that are reachable by the relay UE device.

With Model B discovery, either the source UE device or the relay UE device transmits a discovery message requesting “Are you there?,” and the UE device that receives the discovery message containing the request may respond by transmitting a message indicating the presence of the UE device that received the discovery message. In some examples, Model B discovery is used by the source UE device to ask nearby relay UE devices whether they can reach a target UE device of interest. In some examples, if the target UE device is reachable by a relay UE device, then the relay UE device would be considered a candidate relay UE device for U2U relaying. In some cases, none of the relay UE devices may currently be able to reach the target UE device of interest. However, this does not imply that a relay UE device will not be able to reach a target UE device at a later point in time, since the source UE device, the target UE device, and the candidate relay UE devices are all capable of moving relative to each other.

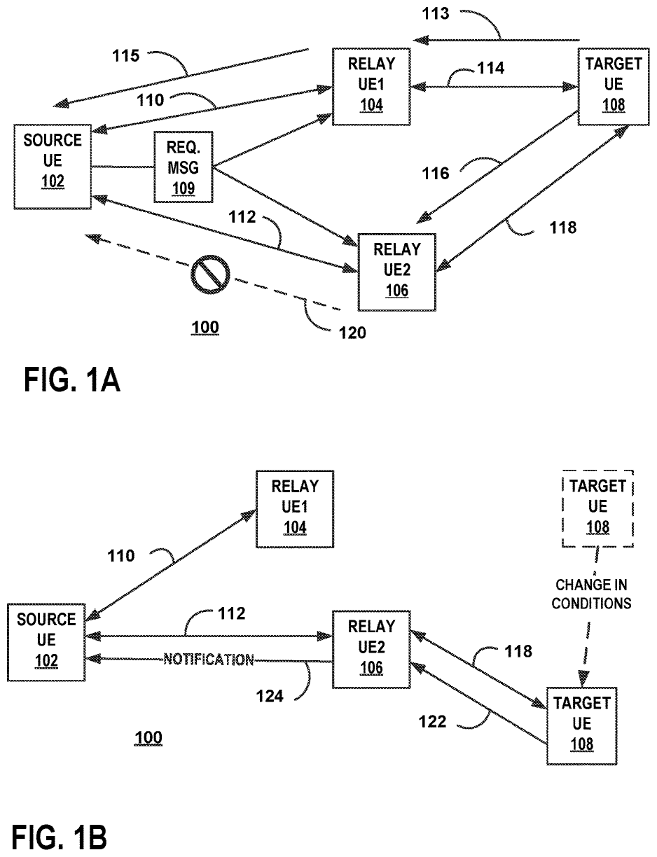

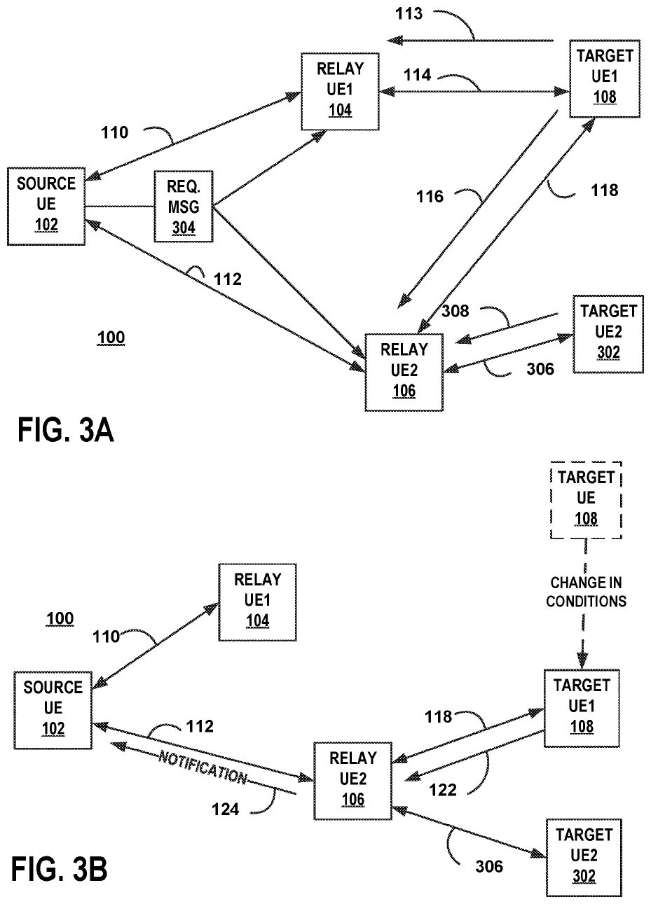

Although the devices, systems, and methods described herein may be utilized in any suitable relay selection and reselection scenario, there are at least two scenarios, in particular, that should be considered. First, after a source UE device establishes an indirect path with a target UE device via a first relay UE device, it is possible that another relay UE device would better serve as the indirect path towards the target UE device, due to the relative mobility of all of the UE devices. Second, a source UE device may be interested in connecting to two target UE devices. In such a situation, the source UE device would typically utilize two, separate indirect paths to each of the respective target UE devices. The first scenario is addressed in more detail below in connection with FIGS. 1A-1B. The second scenario is addressed in more detail below in connection with FIGS. 3A-3B.

Although the techniques discussed herein may be applied to various types of systems and communication specifications, the devices described herein operate in accordance with at least one revision of the 3^{rd} Generation Partnership Project (3GPP) New Radio (NR) V2X communication specification. The techniques discussed herein, therefore, may be adopted by one or more future revisions of communication specifications, although the techniques may be applied to other communication specifications where sidelink or D2D is employed. More specifically, the techniques may be applied to current and future releases of 3GPP NR specifications. For example, the techniques may also be applied to 3GPP NR (3GPP Rel-17) and 3GPP Rel-18.

The devices, systems, and methods described herein are directed to scenarios in which a candidate relay UE device may have previous knowledge of a source UE device's interest in connecting to a specific target UE device, based on a previous request from the source UE device. If the candidate relay UE device determines that a sidelink connection between the candidate relay UE device and the target UE device meet the criteria for establishing a U2U relay connection between the source UE device and the target UE device, the candidate relay UE device informs the source UE device without waiting for a next scheduled Model A transmission period.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

As mentioned above, the devices, systems, and methods described herein are generally applicable to relay selection and reselection but are particularly relevant to two specific scenarios. The system shown in FIGS. 1A-1B addresses the first scenario in which a source UE device establishes an indirect path with a target UE device via a first relay UE device. At a later point in time, due to changes in conditions that may be based on the relative mobility of all of the UE devices, it is determined that another relay UE device would better serve as the indirect path towards the target UE device.

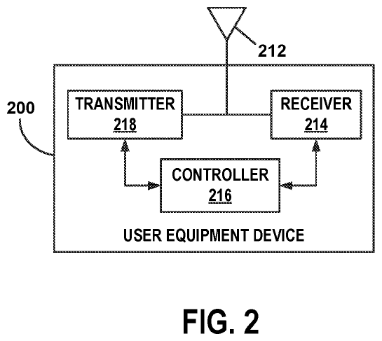

FIG. 2 is block diagram of an example of a UE device 200 suitable for use as any one of the UE devices discussed herein. UE device 200, therefore, is an example of source UE device 102, the first relay UE device (relay UE1) 104, the second relay UE device (relay UE2) 106, the first target UE device (target UE1) 108, and the second target UE device (target UE2) 302. As shown in FIG. 2, user equipment (UE) device 200 comprises controller 216, transmitter 218, receiver 214, and antenna 212, as well as other electronics, hardware, and software code. UE device 200 may be wirelessly connected to a radio access network via a base station (not shown), which provides various wireless services to UE 200. For the example shown in FIG. 1A, UE 104 operates in accordance with at least one revision of the 3rd Generation Partnership Project 5G New Radio (3GPP 5G NR) communication specification. In other examples, UE 104 may operate in accordance with other communication specifications. For the examples shown in FIGS. 1A, 1B, 3A and 3B, all of the UE devices have the same components, circuitry, and configuration as UE 200 from FIG. 2. However, any of the UE devices in FIG. 1A may have components, circuitry, and configuration that differ from UE 200, in other examples.

UE 200 is any fixed, mobile, or portable equipment that performs the functions described herein. The various functions and operations of the blocks described with reference to UE 200 may be implemented in any number of devices, circuits, or elements. Two or more of the functional blocks may be integrated in a single device, and the functions described as performed in any single device may be implemented over several devices.

Controller 216 includes any combination of hardware, software, and/or firmware for executing the functions described herein as well as facilitating the overall functionality of a user equipment device. An example of a suitable controller 216 includes software code running on a microprocessor or processor arrangement connected to memory. Transmitter 218 includes electronics configured to transmit wireless signals. In some situations, transmitter 218 may include multiple transmitters. Receiver 214 includes electronics configured to receive wireless signals. In some situations, receiver 214 may include multiple receivers. Receiver 214 and transmitter 218 receive and transmit signals, respectively, through antenna 212. Antenna 212 may include separate transmit and receive antennas. In some circumstances, antenna 212 may include multiple transmit and receive antennas.

Transmitter 218 and receiver 214 in the example of FIG. 2 perform radio frequency (RF) processing including modulation and demodulation. Receiver 214, therefore, may include components such as low noise amplifiers (LNAs) and filters. Transmitter 218 may include filters and amplifiers. Other components may include isolators, matching circuits, and other RF components. These components in combination or cooperation with other components perform the user equipment device functions. The required components may depend on the particular functionality required by the user equipment device.

Transmitter 218 includes a modulator (not shown), and receiver 214 includes a demodulator (not shown). The modulator can apply any one of a plurality of modulation orders to modulate the signals to be transmitted by transmitter 218. The demodulator demodulates received signals, in accordance with one of a plurality of modulation orders.

FIG. 1A is a block diagram of an example of a system in which a source user equipment (UE) device establishes a UE-to-UE (U2U) relay connection to a target UE device through a first relay UE device and a second relay UE device refrains from responding to a request from the source UE device. In the interest of brevity, FIG. 1A only depicts one source UE device 102, two relay UE devices 104, 106, and one target UE device 108. However, any number of source UE devices, relay UE devices, and target UE devices may be utilized, in other examples.

Source UE device 102 may also be referred to herein as a source UE, a source wireless communication device (WCD), or a source remote UE device. Relay UE devices 104, 106 may also be referred to herein as a relay UE or a relay WCD. Target UE device 108 may also be referred to herein as a target UE, a target WCD, a destination UE device, a destination UE, or a destination WCD. Moreover, any of the UE devices herein may be described as D2D devices when they are transmitting data signals to each other over a communication link using cellular resources instead of communicating through a base station.

For the example of FIG. 1A, the source UE 102 in system 100 transmits a request message 109 indicating a request to establish a UE-to-UE (U2U) relay connection to target UE 108. Relay UE1 104 receives the request message via sidelink connection 110. Relay UE2 106 receives the request message via sidelink connection 112.

In some examples, the request message 109 is a Direct Communication Request message. In other examples, the request message 109 is a Model B discovery request message. In the examples where the request message 109 is a Model B discovery request message, a relay UE device receiving a Model B query from the source UE device sends its own discovery message to the target UE device identified in the Model B discovery request message received from the source UE device. If the target UE device responds to the discovery message sent by the relay UE device, the target UE device is considered “reachable” by the relay UE device. In conventional systems, the relay UE device sends a discovery message response to the source UE device indicating that the target UE device is reachable by the relay UE device.

In the example shown in FIG. 1A, the controller 216 of the relay UE1 104 determines, based on a signal 113 received from target UE 108, that sidelink connection 114 from relay UE1 104 to target UE 108 meets criteria for establishing the U2U relay connection. As described above, the signal received by relay UE1 104 from target UE 108 is a Model B discovery response message, in some examples. In other examples, the signal 113 received by relay UE1 104 from target UE 108 is a sidelink reference signal or a discovery message (e.g., Model A discovery message) sent from target UE 108. After making the determination, relay UE1 104 transmits, via its transmitter 218 and antenna 212, a response message 115 to source UE 102, indicating that relay UE1 104 is capable of facilitating the U2U relay connection to target UE 108. In this manner, relay UE1 104 informs source UE 102 that target UE 108 is “reachable” by relay UE1 104. For the example, therefore, the target is considered reachable if the link 114 meets the criteria.

In the example shown in FIG. 1A, the controller 216 of relay UE2 106 determines, based on a measurement of a signal 116 received from target UE 108, that a sidelink connection 118 from relay UE2 106 to target UE 108 does not meet criteria for establishing the U2U relay connection. In some examples, the measurement of the signal received from target UE 108 is either a Sidelink Discovery Reference Signal Received Power (SD-RSRP) level measurement or a Sidelink Reference Signal Received Power (SL-RSRP) level measurement. In further examples, a minimum sidelink quality threshold level is configured or pre-configured to the relay UE device. In some of these examples, the minimum sidelink quality threshold level is a minimum SD-RSRP level or a minimum SL-RSRP level. In further examples, the relay UE device may receive sidelink threshold configuration information indicating the minimum sidelink quality threshold level. In still further examples, the sidelink threshold configuration information is transmitted to the relay UE device by another UE device or a base station (not shown). In some examples, the relay UE device uses the minimum sidelink quality threshold level to determine if a target UE device is reachable by the relay UE device. More specifically, the minimum sidelink quality threshold level needs to be satisfied before “reachability” can be assumed, in these examples.

In response to the determination that the sidelink connection from relay UE2 106 to target UE 108 does not meet criteria for establishing the U2U relay connection, relay UE2 106 refrains from responding to the request message received from source UE 102. For the example of FIG. 1A, therefore, no Model B Discovery response 120 (or any other signal indicating reachability to target UE 106) is transmitted to source UE 102.

Source UE 102 evaluates the response message received from relay UE1 104 (and any other response messages received from other relay UE devices). Based on the response message(s) received from the relay UE devices, source UE 102 utilizes its controller 216 to select/reselect a relay UE device to establish the U2U relay connection to target UE 108. In the example shown in FIG. 1A, source UE 102 selects/reselects relay UE1 104 and establishes the U2U relay connection to target UE 108 via relay UE1 104. In the example shown in FIG. 1A, the U2U relay connection between source UE 102 and target UE 108 comprises sidelink connection 110 and sidelink connection 114. In some examples, sidelink connection 110 and sidelink connection 114 are both PC5 connections.

Although relay UE2 106 previously refrained from responding to the request message received from source UE 102, relay UE2 106 uses its controller 216 to (1) monitor the sidelink connection from relay UE2 106 to target UE 108, and (2) determine the sidelink connection from relay UE2 106 to target UE 108 has changed such that the sidelink connection meets the criteria for establishing the U2U relay connection. In some examples, the sidelink connection from relay UE2 106 to target UE 108 changes due to one or more of the UE devices moving relative to each other. In other examples, the sidelink connection from relay UE2 106 to target UE 108 changes based on movement of one or more obstructions and/or sources of interference that affect signal transmission/reception by the UE devices.

FIG. 1B is a block diagram of an example of the system of FIG. 1A where the source UE device reestablishes the U2U relay connection with the target UE device through a second relay UE device or otherwise switches to the U2U relay connection through the second relay UE device. For the example, conditions change such that the quality of the sidelink 118 has improved to meet the criteria. In the example shown in FIG. 1B, the UE devices have moved relative to each other such that target UE 108 is now “reachable” by relay UE2 106. The receiver 214 of the relay UE receives a signal 122 from target UE 108 which is used to determine that the quality of the sidelink 118 now meets the criteria. In response to determining that sidelink connection 118 from relay UE2 106 to target UE 108 meets the criteria, relay UE2 106 utilizes its transmitter 218 and antenna 212 to transmit, to source UE 102 before a next scheduled Model A discovery message, a notification message 124 indicating sidelink connection 118 from relay UE2 106 to target UE 108 meets the criteria.

In some examples, the notification message is a Model A discovery message. In the examples in which the notification message is a Model A discovery message, the Model A discovery message may include target UE 108 in a Neighbor List, which is a list of one or more target UE devices, each of which have a communication link with relay UE2 106 with a quality level that meets or exceeds the minimum sidelink quality threshold level. In still further examples, the discovery message transmitted from relay UE2 106 to source UE 102 may also contain a sidelink quality measurement value for each of the target UE devices that are reachable. In some of these examples, the sidelink measurement values may be SD-RSRP measurement values or SL-RSRP measurement values.

In some examples, whether a relay UE device is already PC5 connected to a target UE device can affect relay selection/reselection. This situation may arise when another source UE device may also want to connect to the same target UE device through one of the candidate relay UE devices, which is why the PC5 connection to the target UE device may already be established. Thus, in some examples, when two candidate relay UE devices can reach a target UE device (e.g., as indicated by the contents of their respective Neighbor Lists), the source UE device should select the relay UE device that is already PC5 connected to the target UE device. Therefore, in other examples, the notification message sent from relay UE2 106 to source UE 102 also includes an indication that relay UE2 106 is connected to target UE 108 via a PC5 connection. In further examples, the notification message is a discovery message (e.g., either a Model A or Model B response), which includes a flag (e.g., a bit indicator) that indicates whether relay UE2 106 is connected to target UE 108 via a PC5 connection.

In still further examples, relay UE2 106 may already be facilitating another U2U relay connection from source UE 102 to another target UE device (not explicitly shown in FIGS. 1A-1B) when it is determined that sidelink connection 118 from relay UE2 106 to target UE 108 meets the criteria for establishing the U2U relay connection between source UE 102 and target UE 108. In these examples, relay UE2 106 transmits the notification message (indicating sidelink connection 118 from relay UE2 106 to target UE 108 meets the criteria) to source UE 102 while relay UE2 106 is facilitating another U2U relay connection from source UE 102 to another target UE device. Moreover, in some of these examples, the notification message may be a PC5-Radio Resource Control (PC5-RRC) message sent from relay UE2 106 to source UE 102 rather than a discovery message.

In response to receiving the notification message from relay UE2 106, source UE 102 utilizes its controller 216 to reestablish the U2U relay connection with target UE 108 through relay UE2 106. In the example shown in FIG. 1B, the U2U relay connection between source UE 102 and target UE 108 comprises sidelink connection 112 and sidelink connection 118. In some examples, sidelink connection 112 and sidelink connection 118 are both PC5 connections.

Thus, in the scenario described above in connection with FIGS. 1A-1B, when the source UE device selects/reselects a relay UE device for the indirect path (e.g., U2U relay connection) to the target UE device, it may still be advantageous for other, non-selected candidate relay UE devices to send discovery messages. For example, even if the source UE device is not sending Model B discovery queries, another, non-selected candidate relay UE device may be closer to the target UE device than the previously selected relay UE device. Since a candidate relay UE device may have previous knowledge of the source UE device's interest in connecting to a specific target UE device, based on a previous Model B discovery query from the source UE device, the candidate relay UE device should transmit a Model A discovery message as soon as the target UE device of interest is above SD-RSRP/SL-RSRP threshold(s) without waiting for the next scheduled Model A transmission period, in some examples.

FIG. 3A is a block diagram of an example of the system 100 in which a source UE device 102 establishes a first U2U relay connection to a first target UE device 108 through a first relay UE device and second U2U relay connection to a second target UE device 302 through a second relay UE device 106. The source UE device 102 sends a one or more request messages 304 that request to establish a UE-to-UE (U2U) relay connection to target UE 108 and to establish a UE-to-UE (U2U) relay connection to target UE 302. Relay UE1 104 receives the request message(s) via sidelink connection 110. Relay UE2 106 receives the request message(s) via sidelink connection 112.

For the example of FIG. 3A, relay UE1 104 determines the sidelink 114 to the first target UE (UE1) 108 meets the criteria but the sidelink (not shown) to the second target UE (target UE2) 302 does not meet the criteria. Also, relay UE2 106 determines the sidelink 306 to the second target UE (UE2) 302 meets the criteria but the sidelink 118 to the first target UE (UE1) 308 does not meet the criteria. As a result and in accordance with the techniques discussed above, a first U2U relay connection to the first target UE device (target UE1) 108 through the first relay UE device (relay UE1) is established and a second U2U relay connection to the second target UE device (target UE2) 302 through a second relay UE device (relay UE2) 106 is established. Since the sidelink 118 did not meet the criteria, the second relay UE device (relay UE2) does not send a response to the request 304 to the source UE 102 for the request to establish a U2U connection to the first target device (target UE1) 108. The second relay UE device (relay UE 2) 106, however, retains the information associated with the request 304 while refraining from transmitting a response.

Although the source has established a connections to both target UE devices 108, 302, UE2 302 there could be drawbacks to having two, separate indirect paths to each of the respective target UE devices (e.g., target UE1 108 and target UE2 302). For example, in some cases, the complexity of handling two relay UE devices may be higher than handling one relay UE device. More specifically, in the case of handling two relay UE devices, the increased complexity may be associated with the monitoring of SL-RSRPs for four hops (e.g., two indirect paths, each having two hops). By comparison, in the case of handling one relay UE device, only three hops would need to be monitored (e.g., one hop from the source UE to the relay UE, and one hop from the relay UE to each of the two target UEs). In other cases, there may be limitations on the number of relay UE(s) to which a source UE may connect. Thus, there may be advantages to a source UE device utilizing a single relay UE device to establish U2U relay connections with multiple target UE devices. For the examples herein, the relay UE devices retain the information regarding the requests 304 and facilitate connection through a single relay device to both target UE devices when conditions allow such establishment.

FIGS. 3A-3B are directed to an example where there is a preference to have a single relay UE device facilitating the U2U relay connection to multiple target UE devices and candidate relay UE devices retain knowledge of a source UE device's interest in establishing a relay connection to one or more target UE devices. For example, it is possible that, after a source UE device establishes one or more U2U relay connections (either via a single relay UE device or via multiple relay UE devices), another candidate relay UE device (e.g., either a new relay UE device or one of the existing relay UE devices) may be more suitable for connecting to the target UE devices, if the single candidate relay UE device is within reach of both target UE devices.

In the example of FIG. 3A, source UE 102 transmits a request message indicating a request to establish a first UE-to-UE (U2U) relay connection to target UE1 108 and a request to establish a second U2U relay connection to target UE2 302. Relay UE1 104 receives the request message via sidelink connection 110. Relay UE2 106 receives the request message via sidelink connection 112. The requests 304 may be transmitted in a single request message or in two different request messages. Where two request messages are transmitted, the messages may be transmitted at the same time or at different times. The requests are received by both relay UE devices 104, 106.

Using its controller 216, relay UE2 106 refrains from responding to the request message to establish a U2U connection to the first target UE device (target UE1) 108 in response to determining the sidelink connection from relay UE2 106 to target UE1 108 does not meet criteria for establishing a U2U relay connection but does respond to the request to establish the U2U connection to the second relay UE device (relay UE2) 302. For the example, relay UE2 106 evaluates a signal 308 from target UE2 302 to determine that the sidelink 306 meets the criteria. Relay UE2 106 further uses its controller 216 to monitor the sidelink connection 118 from relay UE2 106 to target UE1 108. In other situations, relay UE2 106 also determines that the sidelink 306 does not meet the criteria and does not respond to either request from the source UE 102. In such situations, relay UE2 106 further uses its controller 216 to (1) monitor the sidelink connection from relay UE2 106 to target UE1 108, and to (2) monitor the sidelink connection from relay UE2 106 to target UE2 302.

For the example of FIG. 3B, the conditions have changed such that the sidelink 306 meets the criteria and the relay UE2 106 sends a notification 124 to source UE 102. Based on a measurement of a signal 122 from the target UE1 108, the controller in the relay UE2 determines the sidelink 118 meets the criteria. In response to determining that sidelink connection 118 from relay UE2 106 to target UE 108 meets the criteria, relay UE2 106 utilizes its transmitter 218 and antenna 212 to transmit, to source UE 102, before a next scheduled Model A discovery message, a notification message 124 indicating sidelink connection 118 from relay UE2 106 to target UE 108 meets the criteria.

In some examples, the notification message is a Model A discovery message. In the examples in which the notification message is a Model A discovery message, the Model A discovery message may include target UE 108 in a Neighbor List, which is a list of one or more target UE devices, each of which have a communication link with relay UE2 106 with a quality level that meets or exceeds the minimum sidelink quality threshold level. In still further examples, the discovery message transmitted from relay UE2 106 to source UE 102 may also contain a sidelink quality measurement value for each of the target UE devices that are reachable. In some of these examples, the sidelink measurement values may be SD-RSRP measurement values or SL-RSRP measurement values.

In some situations, as discussed above, the relay UE2 106 may determine that the sidelinks to both target UE devices 108, 302 do not meet the criteria. In such situations, relay UE2 106 refrains from responding to the request message in response to (1) determining the sidelink connection from relay UE2 106 to target UE1 108 does not meet criteria for establishing a U2U relay connection and determining another sidelink connection 306 to target UE2 302 does not meet criteria for establishing a U2U relay connection. Relay UE2 106 further uses its controller 216 to (1) monitor the sidelink connection from relay UE2 106 to target UE1 108, (2) monitor the sidelink connection from relay UE2 106 to target UE2 302, and (3) determine the sidelink connection from relay UE2 106 to target UE1 108 and the sidelink connection from relay UE2 106 to target UE2 302 have changed such that the sidelink connection from relay UE2 106 to target UE1 108 and the sidelink connection from relay UE2 106 to target UE2 302 meet the criteria for establishing the requested U2U relay connections.

In response to the determination that the sidelink connection from relay UE2 106 to target UE1 108 and the sidelink connection from relay UE2 106 to target UE2 302 meet the criteria, relay UE2 106 transmits a notification message indicating the sidelink connection from relay UE2 106 to target UE1 108 and the sidelink connection from relay UE2 106 to target UE2 302 meet the criteria. In response to receiving the notification message from relay UE2 106, source UE 102 utilizes its controller 216 to reestablish the U2U relay connection with target UE1 108 through relay UE2 106. Source UE 102 also utilizes its controller 216 to establish a U2U relay connection with target UE2 302 through relay UE2 106. In the example shown in FIG. 3B, the U2U relay connection between source UE 102 and target UE1 108 comprises sidelink connection 112 and sidelink connection 118, and the U2U relay connection between source UE 102 and target UE2 302 comprises sidelink connection 112 and sidelink connection 306.

Thus, if a single candidate relay UE device can reach both target UEs 108, 308, the candidate relay UE device should transmit a notification message (e.g., Model A discovery message) to the source UE device, in some examples. If the candidate relay UE device, which is able to reach both target UE devices, is already one of the source UE device's existing relay UE devices, the candidate relay UE device may also inform the source UE device via a PC5-RRC message, rather than via a discovery message.

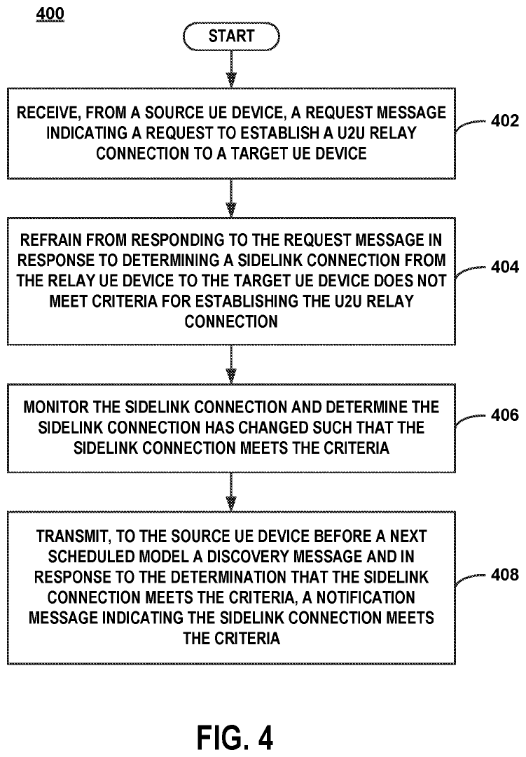

FIG. 4 is a flow chart of an example of a method performed at a relay UE device. For the example, the method may be performed by relay UE1 104.

At step 402, the relay UE device receives, from a source UE device, a request message indicating a request to establish a U2U relay connection to a target UE device. At step 404, the relay UE device refrains from responding to the request message in response to determining a sidelink connection from the relay UE device to the target UE device does not meet criteria for establishing the U2U relay connection. At step 406, the relay UE device monitors the sidelink connection from the relay UE device to the target UE device and determines the sidelink connection has changed such that the sidelink connection meets the criteria. At step 408, the relay UE device transmits, to the source UE device before a next scheduled Model A discovery message and in response to the determination that the sidelink connection meets the criteria, a notification message indicating the sidelink connection meets the criteria.

In other examples, one or more of the steps of method 400 may be omitted, combined, performed in parallel, or performed in a different order than that described herein or shown in FIG. 4. In still further examples, additional steps may be added to method 400 that are not explicitly described in connection with the example shown in FIG. 4.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A relay user equipment (UE) device comprising:
a receiver configured to receive a request message from a source UE device, the request message indicating a request to establish a UE-to-UE (U2U) relay connection to a target UE device;
a controller configured to refrain from responding to the request message in response to determining a sidelink connection from the relay UE device to the target UE device does not meet criteria for establishing the U2U relay connection, the controller configured to monitor the sidelink connection and determine the sidelink connection has changed such that the sidelink connection meets the criteria; and
a transmitter configured to transmit, to the source UE device before a next scheduled Model A discovery message and in response to the determination that the sidelink connection meets the criteria, a notification message indicating the sidelink connection meets the criteria.

2. The relay UE device of claim 1, wherein the transmitter is configured to transmit the notification message while facilitating another U2U relay connection from the source UE device to another target UE device.

3. The relay UE device of claim 1, wherein the notification message is a Model A discovery message.

4. The relay UE device of claim 3, wherein the Model A discovery message includes the target UE device in a Neighbor List.

5. The relay UE device of claim 1, wherein the request message is a Direct Communication Request message.

6. The relay UE device of claim 1, wherein the request message is a Model B discovery request message.

7. The relay UE device of claim 1, wherein:
the request message further indicates a request to establish another U2U relay connection to another target UE device;
the controller is configured to refrain from responding to the request message in response to determining the sidelink connection from the relay UE device to the target UE device does not meet criteria for establishing the U2U relay connection and determining another sidelink connection to the another target UE device does not meet criteria for establishing the another U2U relay connection, the controller configured to monitor the sidelink connection and the another sidelink connection and determine the sidelink connection and the another sidelink connection have changed such that the sidelink connection and the another sidelink connection meet the criteria; and
the transmitter is configured to transmit, in response to the determination that the sidelink connection and the another sidelink connection meet the criteria, the notification message indicating the sidelink connection and the another sidelink connection meet the criteria.

8. The relay UE device of claim 1, wherein the receiver is configured to receive a signal transmitted from the target UE device, and the controller is configured to determine the sidelink connection from the target UE device to the relay UE device does not meet the criteria based on a measurement of the signal.

9. The relay UE device of claim 8, wherein the measurement of the signal is either a Sidelink Discovery Reference Signal Received Power (SD-RSRP) level measurement or a Sidelink Reference Signal Received Power (SL-RSRP) level measurement.

10. The relay UE device of claim 1, wherein the notification message includes an indication that the relay UE device is connected to the target UE device via a PC5 connection.

11. The relay UE device of claim 1, wherein the notification message is a PC5-Radio Resource Control (PC5-RRC) message transmitted to the source UE device.

12. A source user equipment (UE) device comprising:
a transmitter configured to transmit a request message to a first relay UE device and a second relay UE device, the request message indicating a request to establish a UE-to-UE (U2U) relay connection to a target UE device;
a receiver configured to receive, from the first relay UE device, a response message indicating the first relay UE device is capable of facilitating the U2U relay connection to the target UE device; and
a controller configured to establish the U2U relay connection to the target UE device via the first relay UE device,
the receiver further configured to receive, from the second relay UE device, a notification message indicating a sidelink connection between the second relay UE device and the target UE device meets criteria for establishing the U2U relay connection,
the controller further configured to reestablish the U2U relay connection with the target UE device through the second relay UE device in response to the notification message.

13. The source UE device of claim 12, wherein the receiver is configured to receive the notification message before a next scheduled Model A discovery message is transmitted by the second relay UE device.

14. The source UE device of claim 12, wherein the receiver is configured to receive the notification message while the second relay UE device is facilitating another U2U relay connection from the source UE device to another target UE device.

15. The source UE device of claim 12, wherein the notification message is a Model A discovery message.

16. The source UE device of claim 15, wherein the Model A discovery message includes the target UE device in a Neighbor List.

17. The source UE device of claim 12, wherein the request message is a Direct Communication Request message.

18. The source UE device of claim 12, wherein the request message is a Model B discovery request message.

19. The source UE device of claim 12, wherein:
the request message further indicates a request to establish another U2U relay connection to another target UE device,
the receiver is configured to receive, from the second relay UE device, a notification message indicating the sidelink connection and another sidelink connection between the second relay UE device and the another target UE device meet the criteria, the notification message transmitted in response to a determination that the sidelink connection and the another sidelink connection meet the criteria.

20. The source UE device of claim 12, wherein the notification message includes an indication that the second relay UE device is connected to the target UE device via a PC5 connection.

21. The source UE device of claim 12, wherein the notification message is a PC5-Radio Resource Control (PC5-RRC) message transmitted to the source UE device.
